(19) United States
(12) Patent Application Publication
(10) Pub. No.: US 2025/0005233 A1
(43) Pub. Date: Jan. 2, 2025

(54) SYSTEMS AND METHODS FOR SIMULATION OF HYDROGEN INTERACTIONS WITHIN A SUBSURFACE RESERVOIR

(71) Applicant: Ohio State Innovation Foundation, Columbus, OH (US)

(72) Inventors: Joachim MOORTGAT, Columbus, OH (US); Thomas DARRAH, Columbus, OH (US)

(21) Appl. No.: 18/293,932

(22) PCT Filed: Aug. 2, 2022
(86) PCT No.: PCT/IB2022/057174

§ 371 Date: Jan. 31, 2024

Related U.S. Application Data
(60) Provisional application No. 63/203,865, filed on Aug. 2, 2021.

(51) Int. Cl. G06F 30/25; G06F 30/28; G06F 113/08

(52) U.S. Cl. CPC G06F 30/25; G06F 30/28; G06F 2113/08

(57) ABSTRACT

Systems, apparatuses, methods, and computer program products are disclosed for simulating interactions within a subsurface reservoir. An example method includes receiving, by communications circuitry, a data indicating reservoir characteristics of the subsurface reservoir. The example method further includes generating, by a modeling engine and using the received data, a model of the subsurface reservoir, and simulating, using the modeling engine and the generated model, migration of hydrogen within the subsurface reservoir. The example method further includes outputting, by the communications circuitry, an indication of the simulated migration of hydrogen.

### BACKGROUND

Hydrogen is considered a fundamentally important resource in the global transition to a prospective low-carbon future, and its demand is expected to grow significantly over the coming decades as societies look for alternatives to fossil fuels. Although hydrogen is the most abundant element in the universe, the primary sources of usable hydrogen today are either carbon-intensive (such as steam-methane reforming or coal gasification) or energy-intensive (such as electrolysis of water). As a result, most hydrogen is produced inefficiently, and hydrogen is relegated to the role of energy carrier rather than primary energy source. Large volumes of hydrogen are naturally produced in the subsurface of the Earth, but subsurface exploration for natural hydrogen, as well as associated production strategies, are still in their formative stages. Analogous to the state of hydrocarbon exploration in the 1850s, almost all hydrogen drilling targets to date have been discovered accidentally during exploration for petroleum, geothermal, or groundwater resources, or through observations of hydrogen-rich surface seeps.

### BRIEF SUMMARY

The potential for hydrogen generation in continental settings is expansive based on the abundance of suitable source rocks (mafic and ultramafic rocks comprise over 10% of the continental crust). However, the discoveries of natural hydrogen (sometimes also called geological or native hydrogen) have largely been accidental or serendipitous findings or based on observations of elevated hydrogen concentrations in surface seeps. Exploration for geologic accumulations of natural hydrogen has been severely limited by an inadequate understanding of the formations that serve as hydrogen reservoirs, traps, and seals, along with the level of hydrogen consumption in the shallow crust by oxidation, bio-utilization, diffusional loss, and adsorption onto clay minerals. To produce economic volumes of natural hydrogen, an exploration strategy must be based on identification of the appropriate geological settings that enable hydrogen generation and permit retention of hydrogen and prevent the transmission of oxidizing water or fresh water that contains hydrogen-consuming microbes into hydrogen reservoirs. Once identified, drilling technologies used in both the petroleum and geothermal energy industries can be adapted to economically exploit natural hydrogen as a non-carbon source of energy or chemical feedstock.

Methods, apparatuses, and systems are disclosed herein for simulation of various interactions that may occur within subsurface reservoirs. One example method includes receiving, by communications circuitry, data indicating reservoir characteristics of the subsurface reservoir, generating, by a modeling engine and using the received data, a model of the subsurface reservoir, simulating, using the modeling engine and the generated model, migration of hydrogen within the subsurface reservoir, and outputting, by the communications circuitry, an indication of the simulated migration of hydrogen.

In a related embodiment, a corresponding apparatus is provided for simulation of interactions within a subsurface reservoir. The apparatus includes communications circuitry configured to receive data indicating reservoir characteristic of the subsurface reservoir. The apparatus further includes a modeling engine configured to generate, using the received data, a model of the subsurface reservoir, and simulate, using the generated model, migration of hydrogen within the subsurface reservoir. The communications circuitry of the apparatus is further configured to output an indication of the simulated migration of hydrogen.

In another related embodiment, a corresponding computer program product is provided for simulation of interactions within a subsurface reservoir. The computer program product includes at least one non-transitory computer-readable storage medium storing software instructions that, when executed, cause an apparatus to receive data indicating reservoir characteristic of the subsurface reservoir, generate, using the received data, a model of the subsurface reservoir, simulate, using the generated model, migration of hydrogen within the subsurface reservoir, and output an indication of the simulated migration of hydrogen.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 depicts the computational cost versus accuracy for finite difference/volume (FV) and discontinuous Galerkin (DG) simulations.

FIG. 2 illustrates experimental data and CPA-EOS predictions for CO₂ solubilities in water.

FIG. 3 illustrates preliminary simulations of hydrogen migration through heterogeneous formations, leading to stacked “reservoirs.”

FIG. 4 illustrates an example system in which some example embodiments may be used for simulating subsurface reservoirs.

FIG. 5 illustrates a schematic block diagram of example circuitry embodying a system device that may perform various operations in accordance with some example embodiments described herein.

FIG. 6 illustrates an example flowchart for simulation of interactions within a subsurface reservoir, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of industrial computers, desktop computers, personal data assistants (PDAs), laptop computers, tablet computers, smart books, personal computers, smartphones, wearable devices (such as headsets, smartwatches, or the like), programmable logic controllers (PLCs), programmable automation controllers (PACs), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

### Overview

Due to the lack of awareness of the existence of natural hydrogen accumulation in the subsurface, historically there has not been a significant demand for natural hydrogen exploration techniques. As a result, there is a lack of knowledge of the extant volumes of hydrogen accumulation in the subsurface, and no adequate conceptual model for identifying specific locations of subsurface accumulations of hydrogen. Thus, until now it has been very difficult to identify and evaluate subsurface natural hydrogen resources for extraction, as well as providing production forecasts. Similarly, great uncertainties remain regarding storage of hydrogen in the subsurface. Methods, apparatuses, systems, and computer program products are described herein that enable the simulation of hydrogen reservoirs in the subsurface to facilitate understanding of their potential as targets for hydrogen production and/or storage. Specific details regarding the configuration of some example embodiments are provided below.

### Subsurface Hydrogen Formation

In natural systems, the hydration of Fe-rich igneous rocks containing abundant olivine and pyroxene minerals is known to produce hydrogen, magnetite (Fe₃O₄), and other iron-bearing minerals, through the serpentinization reactions tabulated below (Table 1). While most often observed along mid-ocean ridges where seawater interacts with heated mafic and ultramafic rocks, these reactions can also occur in continental settings where groundwater contacts Fe-rich igneous intrusions, which encompass around 10% of the continental crust globally. Where adequate geologic settings environmental conditions (e.g., temperature, pH, oxygen fugacity, chemical composition, and pressure), and time of water-rock interactions exist, economic volumes of natural hydrogen are generated and can potentially be exploited as a carbon-free energy source.

TABLE 1
Hydrogen-Generating Serpentinization Reactions
Serpentinization Reactions

| | Mineral | | Moles of Igneous | Moles of |
|---|---|---|---|---|
| Mineral | Phase | Reaction | Material | H₂ |
| Olivine | Fayalite | 3Fe₂SiO₄ + 2H₂O → 2Fe₃O₄ + 3SiO₂ + 2H₂ | 3 | 2 |
| Pyroxene | Ferrosilite | 3Fe₂Si₂O₆ + 2H₂O → 2Fe₃O₄ + 6SiO₂ + 2H₂ | 3 | 2 |
| Olivine | Forsterite | 2Mg₂SiO₄ + 3H₂O → Mg₃Si₂O₅(OH)₄ + Mg(OH)₂ | 2 | 0 |

Subsurface exploration for natural hydrogen, as well as associated production strategies, however, are in their formative stages and suffer from a fundamental misunderstanding of the optimal geologic settings and subsurface environmental conditions that both produce large quantities of natural hydrogen and suitably retain natural hydrogen (i.e., prevent it from being consumed or transformed to another chemical phase) over time. This would allow natural hydrogen to accumulate and be stored in accessible and economic reservoirs in the subsurface. For example, the long-term persistence of accumulated hydrogen in the subsurface is highly susceptible to biodegradation or chemical oxidation even at relatively modest temperatures (15-200° C.), lost from reservoir fluids by clay adsorption or diffusive loss through sealing units, and/or consumed by abiogenic methane formation at temperature above ˜200° C. While many of these factors are also relevant to oil and gas resources, sensitivity to these conditions is significantly greater for the highly labile hydrogen molecule.

Without an adequate understanding of these factors and the tools to predict their characteristics in the subsurface, the development of an exploration strategy and/or drilling program to exploit natural hydrogen accumulations would be inherently random, chaotic, and, as evidenced by the early history of petroleum exploration, not economically or technically sound. Even today, despite significant technological advances in subsurface science, seep-drilling and wildcatting for hydrocarbon resources remain extremely low probability (albeit occasionally high reward) endeavors. A thorough review of current hydrogen drilling strategies reveals that these same naïve strategies are being deployed to explore for natural hydrogen today. Based on the behavior of hydrogen, significantly greater reliance on predictive subsurface characteristics and data science and data processing techniques are needed to enable the development of natural hydrogen exploration and production strategies.

As a closely related process, injection of (natural or generated) hydrogen in subsurface formations is being considered as an energy storage pathway. The success of this process requires a thorough understanding and modeling of the phase behavior, chemistry, and migration pathways of hydrogen-brine mixtures in geological formations. Monitoring. Verification, and Accounting (MVA) strategies will have to be developed for regulatory agencies to make subsurface hydrogen storage viable. The reservoir simulation tools described below are critical in achieving those goals.

### Reservoir Simulation Tools

Software-based reservoir modeling solutions are, for reasons laid out previously, critically important for evaluating the potential of various geological formations as targets for hydrogen production. However, many of the modeling solutions relied upon in the petroleum industry and geohydrology community are not reliable and/or not efficient. An embodiment of the present disclosure (Osures) provides a simulator for multiphase multicomponent fluid flow and transport in heterogeneous porous media that may provide a robust foundational platform upon which hydrogen-specific simulation tools model the complex characteristics of subsurface hydrogen-bearing formations. Osures was developed to provide more accurate simulations than prior art, at least partially due to the usage of state-of-the-art numerical methods and a rigorous foundation of thermodynamics.

Subsurface geological formations generally have complex geometries that require highly flexible meshing for accurate representation. Structured (or logically Cartesian) grids may not accurately describe many subsurface problems in hydrogeology and the recovery of subsurface energy resources. They are also not well suited to model radial flow near wells, and results from commercial simulators may not converge in the near-well region.

The most commonly used numerical method to model flow on structured grids is the finite difference (FD) approach, while finite volume (FV) methods are usually adopted for unstructured grids. In their lowest-order form, both assume element-wise constant scalar variables (such as saturations) and use a two-point flux approximation (TPFA) to compute vectors (fluxes) from (pressure) gradients between two points. On structured grids, FD and FV methods are essentially equivalent. Such lowest-order approximations suffer from excessive numerical dispersion, and grid sensitivity (explained below in [0027]). The former can be reduced through ‘brute force’ by significantly refining the mesh, which is made more feasible by the development of massively parallelized simulators in the industry. However, sufficient mesh refinement is often not feasible when modeling flow in field-scale reservoirs or aquifers. Specifically, it is well known that the TPFA may not converge unless the grid is orthogonal to the tensorial rock permeabilities.

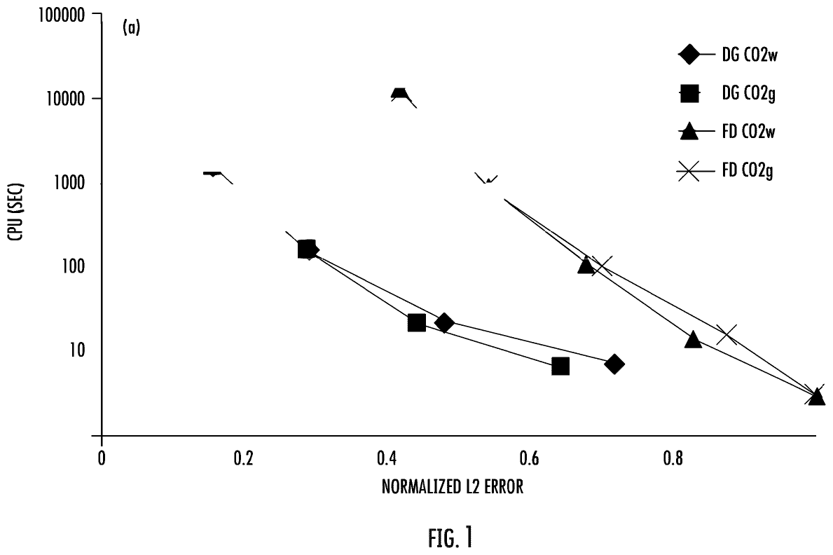

By using (explicit) higher-order numerical methods, Osures may reduce artificial numerical dispersion. This means that one can obtain accurate results on much coarser grids (large grid scales) than those required by commercial reservoir simulators that use (explicit) lowest-order methods. These higher-order methods may make Osures around three orders of magnitude faster than FV and/or FD codes for a given desired accuracy (FIG. 1). Implicit FV methods, which are popular in the industry because they allow for large time-steps, have even higher numerical dispersion. Such excessive numerical dispersion artificially stabilizes flow instabilities that are critical in many problems, including the multiphase brine-hydrogen systems of interest. The mesh refinements that would be required to resolve such features with implicit FV methods are also not feasible.

Recently, significant improvements have been made to the FV approach, for instance to accommodate the full permeability tensor and fractures. To improve FD flux computations on general grids and with tensor permeability, the multipoint flux approximation (MPFA) was introduced. In MPFA, fluxes are reconstructed from the pressures in multiple surrounding elements, similar to the stencil of a standard continuous Galerkin discretization. MPFA models rely on finite elements (FE). FE are the method of choice in many disciplines in science and engineering that involve unstructured grids. However, the FE methods routinely used ignore two essential physical properties of flow through porous media: 1) pressures and fluxes are continuous, even across layers and fractures, while 2) fluid properties are often discontinuous across phase boundaries, fractures, and layers.

To overcome these shortcomings, the discontinuous Galerkin (DG) method may be utilized for modeling flow. The DG method is strictly mass conserving at the elemental level. In a higher-order DG method, compositions or saturations can be updated at all vertices or faces and the values can be discontinuous across faces. This is particularly powerful in fractured or layered reservoirs.

Accordingly, a DG method may be used to equate physical heterogeneities more accurately, such as natural fractures, faults, layers, as well as fluid phase boundaries (e.g., of a migrating hydrogen plume). Fluid flow may be modeled with a (mixed hybrid finite element, MHFE) method that has been shown to avoid the grid sensitivity issues that plague, e.g., the commonly used two-point flux approximations. Such grid sensitivity artificially enhances fluid flow along gridding directions, for instance the vertical and horizontal components on a structured rectangular grid, while underestimating the flow components at some angle, e.g., diagonal flow on a structured grid. These issues are particularly pronounced in problems that are prone to gravitation or viscous flow instabilities, both of which are likely to be relevant when considering an aqueous phase and a hydrogen-rich gaseous phase.

In scenarios where gas (e.g., CO₂) is injected into fractured oil reservoirs, but perhaps also when gaseous hydrogen migrates into a water-saturated fractured formation, gas could relatively quickly fill the fractures. The fractures thus provide large interaction surfaces between, say, gas and oil or water, and steep compositional gradients across such interfaces. Such gradients are the driving force for diffusion and indeed diffusion can be a dominant transport mechanism in fractured formations. Diffusion is an example of a physical process that is not modeled correctly in most commercial simulators. In multicomponent mixtures, diffusion is governed by a full matrix of diffusion coefficients, but commercial simulators only consider the diagonal self-diffusion components, which violates mass balance. Moreover, diffusion only has meaning within a given fluid phase, but many simulators erroneously compute gradients across phase boundaries by computing some gradient between say a CO₂ mole fraction in a gas phase in one grid cell and a CO₂ mole fraction within an aqueous phase in a neighboring grid cell.

A commonly used approach in the industry to deal with fractured formations is a so-called dual-porosity, or dual-porosity-dual-permeability, model. In this approach, the fracture network and the rock matrix are modeled on two different grids; all the flow is assumed to occur only in the fractures while the matrix only facilitates fluid storage. Interactions between the fracture and matrix grids are represented by empirical transfer functions. These methods are highly computationally expensive and work reasonably well for simple single-phase problems. However, the transfer functions are utterly unsuitable for more complex multiphase and multicomponent problems, especially when gravity plays a relevant role, when fluids drain or imbibe from one matrix block to another across fractures, when diffusion is important, etc. Moreover, dual-porosity methods assume a sugar-cube configuration of uniformly distributed fractures on structured grids, none of which is representative of more realistic fracture patterns.

In fractured and/or strongly heterogeneous formations, in particular, Fickian diffusion can be a critical transport mechanism. If the fractures have a high permeability and the rock matrix is relatively tight, advective flow is predominantly through the fractures. However, even in unfractured domains, there are fundamental weaknesses in the way Fickian diffusion has been modeled in the past. The classical Fick's law has been generalized to multicomponent mixtures by considering a diagonal matrix of diffusion coefficients. However, one can easily demonstrate that a diagonal matrix of diffusion coefficients can only satisfy mass balance when all the diagonal components are identical, that is when a scalar diffusion coefficient is used. By using different diagonal diffusion coefficients, diffusion will cause an unphysical molar imbalance which in turn results in pressure oscillations.

Such pressure oscillations are not necessarily observed because they drive convective fluxes that will quickly equilibrate the system but, nevertheless, reduce the overall reliability of simulations using this approach. As a first step to improve the modeling of Fickian diffusion, the full matrix of composition dependent diffusion coefficients may be incorporated into a model, based on irreversible thermodynamics. By incorporating the off-diagonal diffusion coefficients, we not only satisfy molar balance but can also model various diffusion phenomena that cannot be described by classical Fick's law.

Capillary drainage and imbibition are transport mechanisms driven by gradients in phase saturations. These processes can be particularly important in highly heterogeneous and/or fractured media for the same reasons as described above for diffusion: when a more mobile phase fills high permeability conduits for flow (such as fractures), large interfaces can develop across which the saturation gradients are steep. This, too, is a process that cannot be captured reliably in dual porosity fractured models except under highly simplified conditions. Fortunately, capillarity can be incorporated without much complication in the finite element discrete fracture models discussed above, as was also extensively verified by modeling detailed laboratory experiments. Capillarity has the potential to be an important trapping mechanism for hydrogen in formations that do not appear to have a particularly tight cap rock, e.g., if the hydrogen-gas pressure is below the capillary entry pressure of a particular overlying rock facies.

A commonly used approach in the industry for modeling the phase behavior or multiphase multicomponent systems is the cubic Peng-Robinson EOS. The PR-EOS is widely used in the petroleum industry to model hydrocarbon phases, even in combination with specifies like CO₂ and nitrogen. However, in fluid mixtures that contain polar molecules like asphaltenes or water, the phase behavior is more complex and not described well by the PR-EOS. Polar molecules self-associate (direct hydrogen bonding between H₂O molecules) and also ‘cross-associate’ with molecules like CO₂ and H₂S, which have a permanent polar moment, and light hydrocarbons like methane, which have a temporary polar moment induced by the presence of H₂O molecules. None of this is described by PR-EOS, but PR-EOS (and a few other similar cubic EOS) are still widely used for problems that involve water by tweaking certain parameters (e.g., by using different values of binary interaction coefficients in each fluid phase).

Alternatively, in the (geo-) hydrology community, all species dissolved in the aqueous phase are typically considered to be at low trace-level concentrations and solubilities are derived from empirical correlations like (different versions of) Henry's law. Such correlations, however, cannot account for the (non-linear) effects of the presence of multiple dissolved species (e.g., competitive dissolution of CO₂ and CH₄). Osures may include extremely efficient and robust tools that rigorously satisfy thermodynamic equilibrium, even near critical points. Specifically, full phase stability analyses guarantee the global minimum of Gibbs free energy and phase-split computations guarantee the equality of species fugacities in all phases.

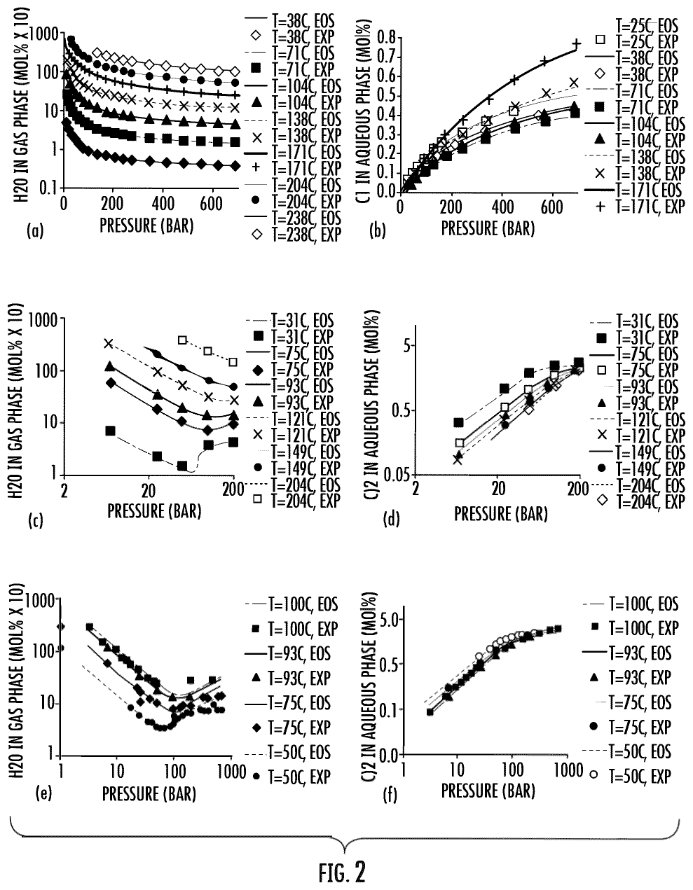

The Osures thermodynamics packages (and fluid flow equations) may allow for up to three phases and the transfer of all species between all phases. The three phases can be oil-gas-water or gas plus two distinct oleic liquid phases (an important problem in asphaltene precipitation). All computations are based on equations of state (EOS) rather than empirical correlations. To rigorously model the phase behavior of mixtures that contain polar molecules, an EOS was developed that utilizes the PR-EOS to describe the physical interactions but has additional terms that model the self- and cross-association behavior. Conveniently, in the absence of associating species, this ‘cubic plus association’, or CPA-EOS automatically reduces to the familiar PR-EOS. The CPA-EOS is remarkably accurate over a wide range of temperatures and pressures (see, e.g., FIG. 2) but highly non-linear. Considerable challenges had to be overcome to make the use of this EOS feasible in terms of computational cost/efficiency. The Osures phase behavior modeling capabilities will be important in investigating the relatively under-studied mixtures of hydrogen, water, and other species.

Additionally, geochemistry and reactive transport may be incorporated into Osures, using software, such as the USGS' Phreeqc open-source software as our geochemistry engine. Phreeqc can model a wide range of equilibrium and kinetic aqueous and rock-fluid reactions and has been validated against numerous experiments over multiple decades. While Phreeqc itself only has rudimentary 1D transport options, it offers useful interfaces, iPhreeqc and PhreeqcRM, that allow the geochemistry engine to be coupled to more full-fledged flow and transport simulators. Osures may use a sequential iterative approach that first updates the flow and transport and then updates a (decoupled) phase-split and geochemistry problem.

### Example

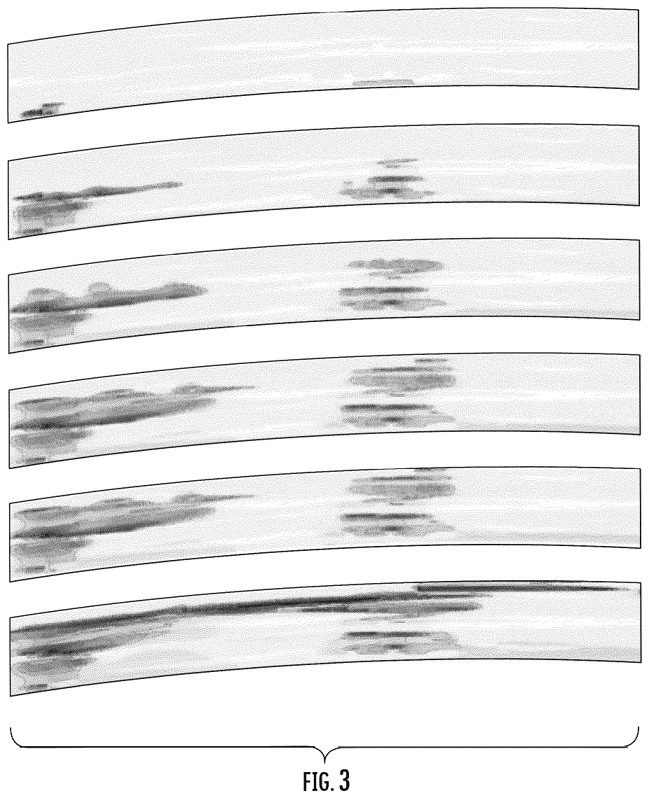

FIG. 3 provides an illustration of a first preliminary simulation that incorporates many of the aforementioned features. Hydrogen enters uniformly from the bottom of a 2 km by 250 m inclined domain, discretized by irregular quadrilateral elements, and with a realistic distribution of facies with permeabilities ranging from 0.07 to 70 md. As a plume of gaseous hydrogen buoyantly rises, it encounters regions of lower permeability, which delay the vertical migration and encourage lateral spreading in the underlying regions of higher permeability. This combination of formation properties and transport mechanisms could result in the shown pockets of high hydrogen concentrations surrounded by regions with almost no hydrogen, even though hydrogen was modeled as entering each bottom grid cell of the domain, and even though there is no true cap rock in this formation.

### System Architecture

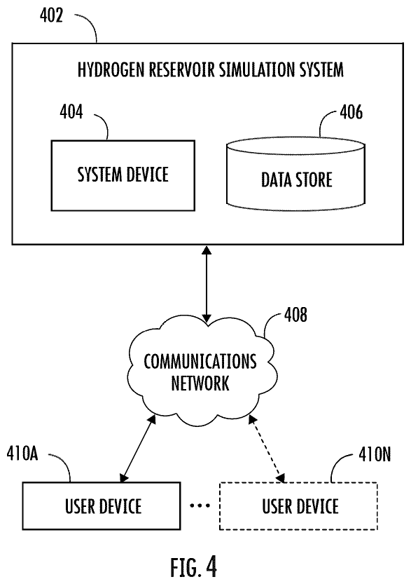

Example embodiments described herein may be implemented using any of a variety of computing devices or servers. To this end, FIG. 4 illustrates an example environment within which various embodiments may operate. As illustrated, a hydrogen reservoir simulation system 402 may include a system device 404 in communication with a data store 406. Although the system device 404 and data store 406 are described in singular form, some embodiments may utilize more than one system device 404 and/or more than one data store 406. Additionally, some embodiments of the hydrogen reservoir simulation system 402 may not require a data store 406 at all, and may instead access relevant geological, geochemical, or geophysical data, when required, from third party data sources (not shown in FIG. 4) via communications network 408 (e.g., the Internet). The hydrogen reservoir simulation system 402 and its constituent components may exchange information via communications network 408 with any number of other devices, such as one or more of user device 410A through user device 410N.

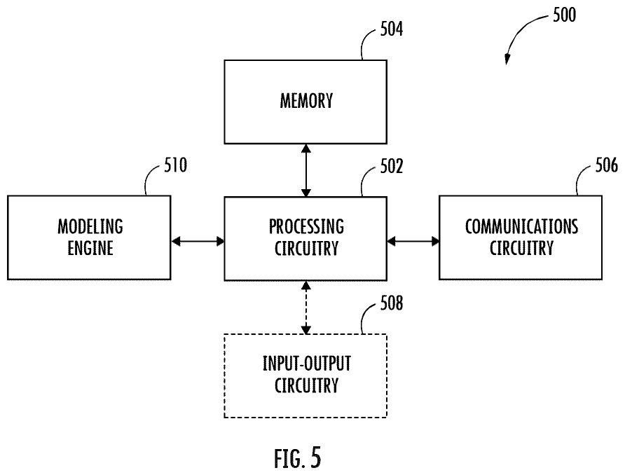

System device 404 may be implemented as one or more servers, which may or may not be physically proximate to other components of the hydrogen reservoir simulation system 402. Furthermore, some components of system device 404 may be physically proximate to the other components of the hydrogen reservoir simulation system 402 while other components are not. System device 404 may receive, process, generate, and transmit data, signals, and electronic information to facilitate the operations of the hydrogen reservoir simulation system 402. To this end, a memory of the system device 404 may store control signals, device characteristics, and access credentials enabling interaction between the hydrogen reservoir simulation system 402 and one or more external devices, such as user device(s) 410A-410N, or the like. Particular components of system device 404 are described in greater detail below with reference to apparatus 500 in connection with FIG. 5.

Data store 406 may comprise a distinct component from system device 404, or may comprise an element of system device 404 (e.g., memory 504, as described below in connection with FIG. 5). Data store 406 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 408). Data store 406 may store information relied upon during operation of the hydrogen reservoir simulation system 402, such as geochemical datasets (e.g., fluid chemistries, well petrophysical logs, seismic reflection data, and the like) about various subsurface formations, as well as seeps, which may be available to the public through government agencies such as the Bureau of Land Management, the U.S. Geological Survey, and the U.S. Department of Energy, or from outside literature, or proprietary sources of gas geochemical data. Data store 406 may, in this regard, store an extensive collection of measurements of hydrogen and other important gas and aqueous geochemical tracers (such as noble gases) from oil and gas, geothermal, CO₂, and other industrial wells, fumaroles, gas seeps, springs, and water supply boreholes. Data store 406 may further store data regarding various stratigraphic units around the world, as well as seismic, gravity, or other geophysical data gathered from a variety of sources and that may be used by the hydrogen reservoir simulation system 402.

The one or more user devices 410A-410N may be embodied by any computing devices known in the art, such as desktop or laptop computers, tablet devices, smartphones, or the like. User devices 410A-410N may be utilized by various individuals interacting or operating the hydrogen reservoir simulation system 402. The one or more user devices 410A-410N need not themselves be independent devices, but may be peripheral devices communicatively coupled to other computing devices.

Although FIG. 4 illustrates an environment and implementation in which the hydrogen reservoir simulation system 402 interacts with any of user devices 410A-410N, in some embodiments users may directly interact with the hydrogen reservoir simulation system 402 (e.g., via input/output circuitry of system device 404), in which case a separate user device may not be required. Whether by way of direct interaction or via a separate user device, a user may communicate with, operate, control, modify, or otherwise interact with the hydrogen reservoir simulation system 402 to perform the various functions and achieve the various benefits described herein.

### Example Implementing Apparatuses

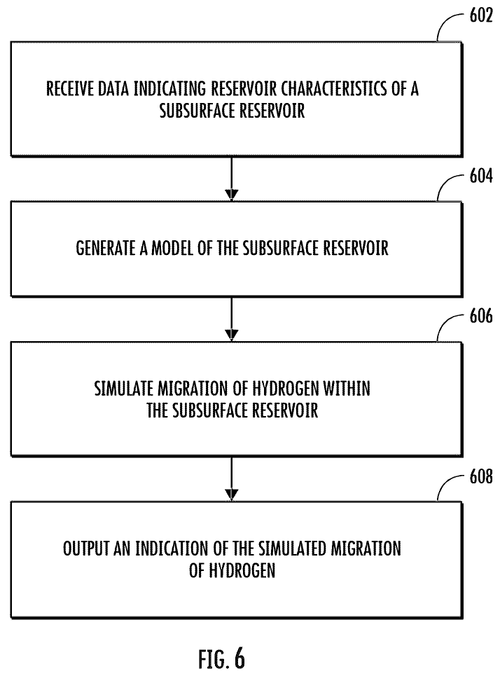

System device 404 of the hydrogen reservoir simulation system 402 (described previously with reference to FIG. 4) may be embodied by one or more computing devices or servers, shown as apparatus 500 in FIG. 5. As illustrated in FIG. 5, the apparatus 500 may include processor 502, memory 504, communications circuitry 506, input-output circuitry 508, and modeling engine 510, each of which will be described in greater detail below. While the various components are only illustrated in FIG. 5 as being connected with processor 502, the apparatus 500 may further comprise a bus (not expressly shown in FIG. 5) for passing information amongst any combination of the various components of the apparatus 500. The apparatus 500 may be configured to execute various operations described above in connection with FIG. 4 and below in connection with FIG. 6.

The processor 502 (and/or co-processor or any other processor assisting or otherwise associated with the processor) may be in communication with the memory 504 via a bus for passing information amongst components of the apparatus. The processor 502 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 500, remote or “cloud” processors, or any combination thereof. As used herein, the term processor may refer to any of a number of types of processing devices, including one or more central processing unit (CPU), designed generally to control operation of the hydrogen reservoir simulation system 402, and one or more separate graphics processing unit (GPU) that may be leveraged in particular by the modeling engine 510 for simulating various aspects of a hydrogen system.

The processor 502 may be configured to execute software instructions stored in the memory 504 or otherwise accessible to the processor. In some cases, the processor may be configured to execute hard-coded functionality. As such, whether configured by hardware or software methods, or by a combination of hardware with software, the processor 502 represent an entity (e.g., physically embodied in circuitry) capable of performing operations according to various embodiments of the present invention while configured accordingly. Alternatively, as another example, when the processor 502 is embodied as an executor of software instructions, the software instructions may specifically configure the processor 502 to perform the algorithms and/or operations described herein when the software instructions are executed.

Memory 504 is non-transitory and may include, for example, one or more volatile and/or non-volatile memories. In other words, for example, the memory 504 may be an electronic storage device (e.g., a computer readable storage medium). The memory 504 may be configured to store information, data, content, applications, software instructions, or the like, for enabling the apparatus to carry out various functions in accordance with example embodiments contemplated herein. As previously mentioned, the data store 406 may be stored by memory 504 in some embodiments.

The communications circuitry 506 may be any means such as a device or circuitry embodied in either hardware or a combination of hardware and software that is configured to receive and/or transmit data from/to a network and/or any other device, circuitry, or module in communication with the apparatus 500. In this regard, the communications circuitry 506 may include, for example, a network interface for enabling communications with a wired or wireless communication network. For example, the communications circuitry 506 may include one or more network interface cards, antennas, buses, switches, routers, modems, and supporting hardware and/or software, or any other device suitable for enabling communications via a network. Furthermore, the communications circuitry 506 may include the processing circuitry for causing transmission of such signals to a network or for handling receipt of signals received from a network.

The apparatus 500 may include input-output circuitry 508 configured to provide output to a user and, in some embodiments, to receive an indication of user input. It will be noted that some embodiments will not include input-output circuitry 508, in which case user input may be received via a separate device such as one of user devices 410A-410N (shown in FIG. 4). The input-output circuitry 508 may comprise a user interface, such as a display, and may further comprise the components that govern use of the user interface, such as a web browser, mobile application, dedicated client device, or the like. In some embodiments, the input-output circuitry 508 may include a keyboard, a mouse, a touch screen, touch areas, soft keys, a microphone, a speaker, and/or other input/output mechanisms. The input-output circuitry 508 may utilize the processor 502 to control one or more functions of one or more of these user interface elements through software instructions (e.g., application software and/or system software, such as firmware) stored on a memory (e.g., memory 504) accessible to the processor 502.

In addition, the apparatus 500 further comprises a modeling engine 510 configured to perform the various software calculations and operations enabling the apparatus 500 to simulate various interactions that may occur within a subsurface reservoir. As described in connection with FIG. 6 below, the modeling engine 510 may utilize processor 502, memory 504, or any other hardware component included in the apparatus 500 to perform these functions. The modeling engine 510 may further utilize communications circuitry 506 to transmit data to, and/or receive data from, a variety of sources (e.g., user devices 410A-410N, as shown in FIG. 4), and may utilize input-output circuitry 508 to transmit data to a user and/or receive data from a user.

Although components 502-510 are described in part using functional language, it will be understood that the particular implementations necessarily include the use of particular hardware. It should also be understood that certain of these components 502-510 may include similar or common hardware. For example, the modeling engine 510, may at times leverage use of the processor 502, memory 504, communications circuitry 506, or input-output circuitry 508, such that duplicate hardware is not required to facilitate operation of these physical elements of the apparatus 500 (although dedicated hardware elements may be used for any of these components in some embodiments, such as those in which enhanced parallelism may be desired). Use of the terms “circuitry,” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 500 to perform the various functions described herein.

Although the modeling engine 510 may leverage processor 502, memory 504, communications circuitry 506, or input-output circuitry 508 as described above, it will be understood that any of these elements of apparatus 500 may include one or more dedicated processor, specially configured field programmable gate array (FPGA), or application specific interface circuit (ASIC) to perform its corresponding functions, and may accordingly leverage processor 502 executing software stored in a memory (e.g., memory 504), communications circuitry 506 or input-output circuitry 508 for enabling any functions not performed by special-purpose hardware elements. In all embodiments, however, it will be understood that the modeling engine 510 is implemented via particular machinery of apparatus 500 designed for performing the functions described herein in connection therewith.

In some embodiments, various components of the apparatus 500 may be hosted remotely (e.g., by one or more cloud servers) and thus need not physically reside on the corresponding apparatus 500. Thus, some or all of the functionality described herein may be provided by third party circuitry. For example, a given apparatus 500 may access one or more third party circuitries via any sort of networked connection that facilitates transmission of data and electronic information between the apparatus 500 and the third-party circuitries. In turn, that apparatus 500 may be in remote communication with one or more of the other components described above as comprising the apparatus 500.

As will be appreciated based on this disclosure, example embodiments contemplated herein may be implemented by an apparatus 500. Furthermore, some example embodiments may take the form of a computer program product comprising software instructions stored on at least one non-transitory computer-readable storage medium (e.g., memory 504). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 500 as described in FIG. 5, that loading the software instructions onto a computing device or apparatus produces a special-purpose machine comprising the means for implementing various functions described herein.

Having described specific components of example apparatus 500, some example embodiments are described below.

### Example Operations

Turning to FIG. 6, example flowcharts are illustrated that contain example operations relating to the simulation of subsurface reservoirs. The operations illustrated in FIG. 6 may, for example, be performed by the hydrogen reservoir simulation system 402 shown in FIG. 4, and more particularly by a system device 404 that may be embodied by an apparatus 500, which is shown and described in connection with FIG. 5. To perform the operations described below, the apparatus 500 may utilize one or more of processor 502, memory 504, communications circuitry 506, input-output circuitry 508, modeling engine 510, and/or any combination thereof. It will be understood that user interaction with the hydrogen reservoir simulation system 402 may occur directly via input-output circuitry 508, or may instead be facilitated by a separate user device (e.g., user devices 410A-410N as shown in FIG. 4), and which may have similar or equivalent physical componentry facilitating such user interaction.

As shown in operation 602, the apparatus 500 includes means, such as memory 504, communications circuitry 506, input-output circuitry 508, or the like, for receiving data indicating reservoir characteristics of a subsurface reservoir. This data may be received from a variety of sources. For instance, the target image may be received from a memory 504 of the apparatus 500, which may have previously stored the data upon its receipt from a separate device. The data may alternatively be received by communications circuitry 506, which may receive the data from a separate device such as a user device (e.g., one of user devices 410A-410N), or a remote data store containing the data. Still further, the information may be received from input-output circuitry 508 in scenarios where the data is provided directly by a user, such as via a peripheral device.

As shown in operation 604, the apparatus 500 includes means, such as modeling engine 510 or the like, for generating a model of the subsurface reservoir. The modeling engine 510 may utilize the data received in operation 604 for this purpose. In some embodiments, generation of the model may comprise generating a grid representing the subsurface reservoir, as described previously (e.g., using a discontinuous Galerkin method).

As shown in operation 606, the apparatus 500 includes means, such as modeling engine 510 or the like, for simulating migration of hydrogen within the subsurface reservoir. The modeling engine 510 may do this in the manner described previously. For instance, the modeling engine 510 may model (i) phase behavior of hydrogen-rich gas within the subsurface reservoir, (ii) Fickian diffusion and capillarity of hydrogen-rich gas within the subsurface reservoir (iii) fluid flow within the subsurface reservoir under a variety of boundary conditions, and/or (iv) an impact of one or more expected reactions affecting hydrogen migration within the subsurface reservoir. The expected reactions affecting hydrogen migration may include, for instance, microbial interaction with hydrogen, although other reactions may also be modeled in some embodiments.

In some embodiments, the simulation of the migration of hydrogen within the subsurface reservoir may simulate migration in response to the application of a treatment to the subsurface reservoir. For instance, the treatment may comprise the injection of carbon dioxide, nitrogen, or water into the subsurface reservoir, or the attempted production of hydrogen from a wellbore drilled into the subsurface reservoir.

In some embodiments, the modeling engine 510 may further be configured to identify, based on the indication of the simulated migration of hydrogen, a candidate hydrogen storage region within the subsurface reservoir. This identification may involve identifying, from the simulated migration of hydrogen, boundary regions within the subsurface reservoir across which hydrogen is unlikely or apparently unable to migrate. The modeling engine 510 may, in this regard, identify a plurality of candidate hydrogen storage regions within the subsurface reservoir. Following identification of one or more of these candidate hydrogen storage regions, the communications circuitry 506 may be configured to output an indication of one or more of the candidate hydrogen storage regions within the subsurface reservoir.

Finally, as shown in operation 608, the apparatus 500 includes means, such as memory 504, communications circuitry 506, input-output circuitry 508, or the like, for outputting an indication of the simulated migration of hydrogen. These modeling results may be transmitted in a variety of sources. For instance, the indication of the simulated migration of hydrogen may be stored in a memory 504 of the apparatus 500 for subsequent use or delivery. Additionally, or alternatively, the indication of the simulated migration of hydrogen may be transmitted by communications circuitry 506 to a separate device such as a user device (e.g., one of user devices 410A-410N), or to a remote data store for storage and subsequent retrieval. Still further, the information may be produced via input-output circuitry 508 in scenarios where the indication of the simulated migration of hydrogen is provided directly to a user via a graphical user interface, or to a peripheral device possessed by a user interacting with the apparatus 500.

As described above, example embodiments provide methods and apparatuses that enable improved simulation and evaluation of subsurface hydrogen accumulations. Considering the recent and expected future growth in demand for hydrogen in combination with low carbon-intensity and/or low energy-intensity of current methods for generating human-made hydrogen, there is a large and growing need for tools enabling the production of natural hydrogen in the subsurface. Example embodiments provide such tools insofar as they enable more accurate characterization of the productive capacity of various subsurface formations where hydrogen has accumulated.

FIG. 6 illustrates operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for simulation of interactions within a subsurface reservoir, the method comprising:
receiving, by communications circuitry, data indicating reservoir characteristic of the subsurface reservoir;
generating, by a modeling engine and using the received data, a model of the subsurface reservoir;
simulating, using the modeling engine and the generated model, migration of hydrogen within the subsurface reservoir; and
outputting, by the communications circuitry, an indication of the simulated migration of hydrogen.

2. The method of claim 1, wherein generating the model of the subsurface reservoir includes:
generating, by the modeling engine and using the data, a grid representing the subsurface reservoir.

3. The method of claim 2, wherein generating the grid utilizes a discontinuous Galerkin method.

4. The method of claim 1, wherein simulating the migration of hydrogen within the subsurface reservoir includes modeling one or more of:
phase behavior of hydrogen-rich gas within the subsurface reservoir;
Fickian diffusion and capillarity of hydrogen-rich gas within the subsurface reservoir;
fluid flow within the subsurface reservoir under a variety of boundary conditions; or
an impact of one or more expected reactions affecting hydrogen migration within the subsurface reservoir.

5. The method of claim 4, wherein the one or more expected reactions include microbial interaction with hydrogen.

6. The method of claim 1, wherein simulating the migration of hydrogen comprises simulating the migration of hydrogen in response to application of a treatment to the subsurface reservoir.

7. The method of claim 6, wherein the treatment comprises injection of carbon dioxide, nitrogen, or water into the subsurface reservoir or attempted production of hydrogen from a wellbore drilled into the subsurface reservoir.

8. The method of claim 1, further comprising:
identifying, based on the indication of the simulated migration of hydrogen, a candidate hydrogen storage region within the subsurface reservoir; and
outputting an indication of the candidate hydrogen storage region.

9. An apparatus for simulation of interactions within a subsurface reservoir, the apparatus comprising:
communications circuitry configured to receive data indicating reservoir characteristic of the subsurface reservoir; and
a modeling engine configured to:
generate, using the received data, a model of the subsurface reservoir, and
simulate, using the generated model, migration of hydrogen within the subsurface reservoir,
wherein the communications circuitry is further configured to output an indication of the simulated migration of hydrogen.

10. The apparatus of claim 9, wherein the modeling engine is configured to generate the model of the subsurface reservoir by:
generating, using the data, a grid representing the subsurface reservoir.

11. The apparatus of claim 10, wherein the modeling engine is configured to generate the grid using a discontinuous Galerkin method.

12. The apparatus of claim 9, wherein the modeling engine is configured to simulate the migration of hydrogen within the subsurface reservoir by modeling one or more of:
phase behavior of hydrogen-rich gas within the subsurface reservoir;
Fickian diffusion and capillarity of hydrogen-rich gas within the subsurface reservoir;
fluid flow within the subsurface reservoir under a variety of boundary conditions; or
an impact of one or more expected reactions affecting hydrogen migration within the subsurface reservoir.

13. The apparatus of claim 12, wherein the one or more expected reactions include microbial interaction with hydrogen.

14. The apparatus of claim 9, wherein the modeling engine is configured to simulate the migration of hydrogen in response to application of a treatment to the subsurface reservoir, and wherein the treatment comprises injection of carbon dioxide, nitrogen, or water into the subsurface reservoir or attempted production of hydrogen from a wellbore drilled into the subsurface reservoir.

15. (canceled)

16. The apparatus of claim 9,
wherein the modeling engine is further configured to identify, based on the indication of the simulated migration of hydrogen, a candidate hydrogen storage region within the subsurface reservoir; and
wherein the communications circuitry is further configured to output an indication of the candidate hydrogen storage region.

17. A computer program product for simulation of interactions within a subsurface reservoir, the computer program product comprising at least one non-transitory computer-readable storage medium storing software instructions that, when executed, cause an apparatus to:
receive data indicating reservoir characteristic of the subsurface reservoir;
generate, using the received data, a model of the subsurface reservoir;
simulate, using the generated model, migration of hydrogen within the subsurface reservoir; and
output an indication of the simulated migration of hydrogen.

18. The computer program product of claim 17, wherein generating the model of the subsurface reservoir includes:
generating, using the data, a grid representing the subsurface reservoir.

19. (canceled)

20. The computer program product of claim 17, wherein simulating the migration of hydrogen within the subsurface reservoir includes modeling one or more of:
phase behavior of hydrogen-rich gas within the subsurface reservoir;
Fickian diffusion and capillarity of hydrogen-rich gas within the subsurface reservoir;
fluid flow within the subsurface reservoir under a variety of boundary conditions; or
an impact of one or more expected reactions affecting hydrogen migration within the subsurface reservoir.

21. (canceled)

22. The computer program product of claim 17, wherein simulating the migration of hydrogen comprises simulating the migration of hydrogen in response to application of a treatment to the subsurface reservoir, and wherein the treatment comprises injection of carbon dioxide, nitrogen, or water into the subsurface reservoir or attempted production of hydrogen from a wellbore drilled into the subsurface reservoir.

23. (canceled)

24. The computer program product of claim 17, wherein the software instructions, when executed, further cause the apparatus to:
identify, based on the indication of the simulated migration of hydrogen, a candidate hydrogen storage region within the subsurface reservoir; and
output an indication of the candidate hydrogen storage region.
